(19) United States
(12) Patent Application Publication
(10) Pub. No.: US 2025/0190010 A1
(43) Pub. Date: Jun. 12, 2025

(54) DISPLAY DEVICE OPERATING IN LANDSCAPE MODE OR PORTRAIT MODE, AND METHOD FOR CONTROLLING SAME

(71) Applicant: SAMSUNG ELECTRONICS CO., LTD., Suwon-si (KR)

(72) Inventors: Kisung LEE, Suwon-si (KR); Youngtae kim, Suwon-si (KR); Bonseuk Goo, Suwon-si (KR); Byungseok Soh, Suwon-si (KR); Youngchol Lee, Suwon-si (KR); Weonhee Lee, Suwon-si (KR)

(73) Assignee: SAMSUNG ELECTRONICS CO., LTD., Suwon-si (KR)

(21) Appl. No.: 19/056,367

(22) Filed: Feb. 18, 2025

Related U.S. Application Data
(63) Continuation of application No. PCT/KR2023/010620, filed on Jul. 21, 2023.

(30) Foreign Application Priority Data
Sep. 1, 2022 (KR) 10-2022-0110856
Oct. 26, 2022 (KR) 10-2022-0139392

(51) Int. Cl. G06F 1/16; F16M 11/10; G06F 3/16

(52) U.S. Cl. CPC G06F 1/1605; F16M 11/105; G06F 3/165

(57) ABSTRACT

A display device is disclosed. The display device includes a display which can operate in landscape mode and in portrait mode, a stand for supporting the display, a connection assembly for connecting the display and the stand, a speaker on the back of the display, and a wave guide provided on the back of the display. The wave guide includes a first wave guide on the rear surface of the display and a a second wave guide on the rear surface of the display. When the display is in the landscape mode, the first wave guide is configured to output a sound of the speaker therethrough and when the display is in the portrait mode, the second waveguide is configured to output the sound of the speaker therethrough.

### CROSS-REFERENCES TO RELATED APPLICATIONS

This application is a continuation of International Application No. PCT/KR2023/010620, filed on Jul. 21, 2023, which claims priority to Korean Application No. 10-2022-0110856, filed on Sep. 1, 2022, and Korean Patent Application No. 10-2022-0139392, filed on Oct. 26, 2022, in the Korean Intellectual Property Office, the disclosures of which are incorporated by reference herein in their entireties.

### BACKGROUND

### 1. Field

The disclosure relates to a display device and a method for controlling the same, and more particularly, to a display device which outputs sound based on a display mode of the display device operating in a landscape mode or a portrait mode and a method for controlling the same.

### 2. Description of Related Art

Recently with the development of electronic technologies, various electronic devices have been developed. In particular, a rotatable display device has been recently developed.

The rotatable display device, if a user input for rotation is inputted, may rotate a display disposed in a landscape state to be in a portrait state or rotate the display disposed in the portrait state to be in the landscape state.

In the related art, when a rotatable display outputs sound, the display needs to have a plurality of speakers to provide optimized sound for each of the landscape mode and the portrait mode. For example, a speaker operating in the landscape mode may output each of left channel sound and right channel sound in the landscape mode of the display device, and a speaker operating in the portrait mode may output each of left channel sound and right channel sound in the portrait mode of the display device. Thus, dedicated speakers for each mode were needed.

In the related art, it was necessary to have each of the speaker operating in the landscape mode and the speaker operating in the portrait mode and thus, various speakers are included in the rotatable display device, with only some of the various speakers being used to output sound according to whether it was in the landscape mode or the portrait mode.

Accordingly, there is a growing need for a device and a method thereof that outputs optimized sound for each of the landscape mode and the portrait mode while the display device does not have multiple speakers or while using all speakers provided in the display device.

### SUMMARY

A display device according to an embodiment of the disclosure includes a display operable in a landscape mode or a portrait mode, a stand supporting the display, a connection assembly connecting the display and the stand, a speaker provided on a rear surface of the display, and a wave guide in the speaker on the rear surface of the display. The wave guide includes a first wave guide on the rear surface of the display; and a second wave guide on the rear surface of the display. When the display is in the landscape mode, the first wave guide is configured to output a sound of the speaker therethrough, and when in the portrait mode, the second waveguide is configured to output the sound of the speaker therethrough.

According to an embodiment of the disclosure, in a method of controlling a display device, the display device includes a display operable in a landscape mode and in a portrait mode; a stand supporting the display; a connection assembly connecting the display and the stand; a speaker on a rear surface of the display; and a wave guide in the speaker on the rear surface of the display and comprising a first wave guide corresponding to the landscape mode and a second wave guide corresponding to the portrait mode. The method includes: outputting a sound output by the speaker through the first wave guide in the landscape mode; and outputting the sound output by the speaker through the second wave guide in the portrait mode.

According to an embodiment of the disclosure to achieve the purpose of the disclosure, in a computer readable recording medium including a program for executing a method of controlling a display device, the display device includes a display operable in a landscape mode and in a portrait mode; a stand supporting the display; a connection assembly connecting the display and the stand; a speaker on a rear surface of the display; and a wave guide on the rear surface of the display and comprising a first wave guide corresponding to the landscape mode and a second wave guide corresponding to the portrait mode. The operation includes: outputting a sound output by the speaker through the first wave guide in the landscape mode; and outputting the sound output by the speaker through the second wave guide in the portrait mode.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a landscape mode and a portrait mode of a display device according to an embodiment;

FIG. 2 is a block diagram illustrating a configuration of a display device according to an embodiment;

FIG. 3 is a view illustrating a rear surface of a display device in each of the landscape mode and the portrait mode according to an embodiment;

FIG. 4 is a right side view illustrating first and second connection parts connecting a display and a stand according to an embodiment;

FIG. 5 is a right side view illustrating coupling of a first connection part and a second connection part according to an embodiment;

FIG. 6 is a rear view and a plan view of a display device in a landscape mode according to an embodiment;

FIG. 7 is a view illustrating a first connection part, a second connection part, and a wave guide in a landscape mode according to an embodiment;

FIG. 8 is a view illustrating a first connection part, a second connection part, and a wave guide in a portrait mode according to an embodiment;

FIG. 9 is a plan view illustrating a speaker according to an embodiment;

FIG. 10 is a rear view illustrating a speaker according to an embodiment; and

FIG. 11 is a flow chart illustrating a method of controlling a display device according to an embodiment.

### DETAILED DESCRIPTION

Example embodiments of the disclosure will be described with reference to the appended drawings hereinafter.

The terms used in embodiments of the disclosure are selected as general terms which are currently widely used as much as possible in consideration of functions in the disclosure but may be varied depending on intention of those skilled in the art, a precedent, appearance of new technologies, or the like. Also, there is a term which is arbitrarily selected by the applicant in a certain case and in this case, its meaning will be specifically described in the relevant description part of the disclosure. Therefore, the term used in the disclosure should be defined based on the meaning of the term and the entire content throughout the disclosure rather than the simple name of the term.

In the specification, the expression such as “have”, “may have”, “include”, or “may include” denotes the existence of such a characteristic (e.g. a numerical value, a function, an operation, or a component such as a part) and does not exclude the existence of additional characteristics.

The expression “at least one of A and/or B” should be interpreted to mean any one of “A” or “B” or “A and B”.

The expression “1st”, “2nd”, “first”, “second”, or the like used in the specification may be used to describe various elements regardless of any order and/or degree of importance, wherein such expression is used only to distinguish one element from another element and is not intended to limit the relevant element.

The description in the disclosure that one element (e.g. a first element) is “(operatively or communicatively) coupled with/to” or “connected to” another element (e.g. a second element) should be interpreted to include both the case where the one element is directly coupled to the another element, and the case where the one element is coupled to the another element through the other element (e.g. a third element).

A singular expression includes a plural expression, unless obviously differently defined in the context. In the application, the term such as “include” or “consist of” should be construed as designating that there are such characteristics, numbers, steps, operations, components, parts, or a combination thereof described in the specification but not as excluding in advance possibility of the existence or addition of one or more other characteristics, numbers, steps, operations, components, parts, or a combination thereof.

In the disclosure, “module” or “part” may perform at least one function or operation and may be implemented as hardware or software, or as a combination of hardware and software. Also, a plurality of “modules” or “parts” may be integrated into at least one module and implemented as at least one processor, excluding a “module” or a “part” that needs to be implemented as specific hardware.

At least one of the components, elements, modules, parts, and units (collectively “components” in this paragraph) represented by a block or part in the drawings herein may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), a microprocessor, or the like that performs the respective functions.

In the specification, the term “user” may refer to a person who uses an electronic device or a device (e.g. an Artificial Intelligence (AI) electronic device) that uses an electronic device.

Hereinafter, an embodiment of the disclosure is more specifically described with reference to the appended drawings.

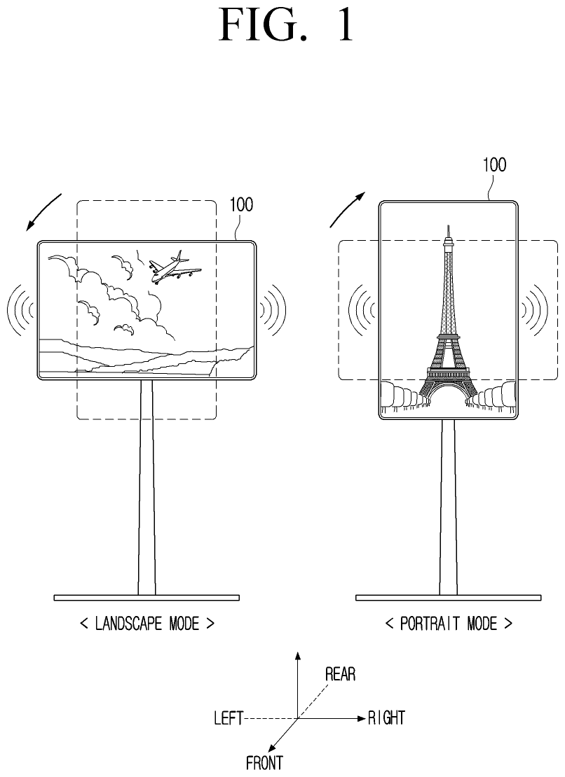

FIG. 1 is a view illustrating a landscape mode and a portrait mode of a display device according to an embodiment.

With reference to FIG. 1, a display device 100 according to an embodiment of the disclosure may provide an image. The display device 100 may be implemented as a TV but is not limited thereto, wherein it may be applied to any device having a display function such as a video wall, a large format display (LFD), Digital Signage, a Digital Information Display (DID), a projector display without limitations. Also, the display device 100 may be implemented as various shapes of displays such as a liquid crystal display (LCD), an organic light-emitting diode (OLED), Liquid Crystal on Silicon (LCoS), a Digital Light Processing (DLP) display panel, a quantum dot (QD) display panel, or a quantum dot light-emitting diode (QLED).

In particular, the display device 100 according to an embodiment may operate in any one display mode of a transverse mode or a longitudinal mode (otherwise, a display mode, an output mode, etc.).

Here, the transverse mode may be a display mode in which a horizontal ratio of a display included in the display device 100 is longer than a vertical ratio thereof as shown in a left side of FIG. 1. The longitudinal mode may be a display mode in which a vertical ratio of the display included in the display device 100 is longer than a horizontal ratio thereof as shown in a right side of FIG. 1.

The transverse mode may be referred to as a horizontal direction mode, a landscape mode, or the like but for convenience of the description, it is commonly referred to as the landscape mode, and the longitudinal mode may be referred to as a vertical direction mode, a portrait mode, or the like but for convenience of the description, it is commonly referred to as the portrait mode.

According to an embodiment, the display device 100 may output sound through a speaker included in the display device 100. For example, in the landscape mode, the display device 100 may output sound through the speaker to each of a left side and a right side with reference to a front surface of the display device 100, and in the portrait mode, it may output sound through the speaker to each of the left side and the right side with reference to the front surface of the display device 100.

Because each of the left side and the right side of the display device 100 in the landscape mode corresponds to an upper side (or a lower side) and a lower side (or an upper side) of the display device 100 in the portrait mode, and each of the left side and the right side of the display device 100 in the portrait mode corresponds to an upper side (or a lower side) and a lower side (or an upper side) of the display device 100 in the landscape mode, to output sound to each of the left side and the right side according to stereo sound implementation with reference to the front surface of the display device 100 in the landscape mode, there is a need for having a speaker outputting sound in the left side and a speaker outputting sound in the right side, and to output sound to each of the left side and the right side with reference to the front surface of the display device 100 in the portrait mode, there is a need for having a speaker outputting sound in the left side and a speaker outputting sound in the right side. That is, there is a need for having at least four sound.

Hereinafter, according to various embodiments, even though the display device 100 includes less than 4 speakers, a structure of the display device 100 capable of outputting sound to each of the left side and the right side in the landscape mode and outputting sound to each of the left side and the right side in the portrait mode and an operation of the display device 100 are described.

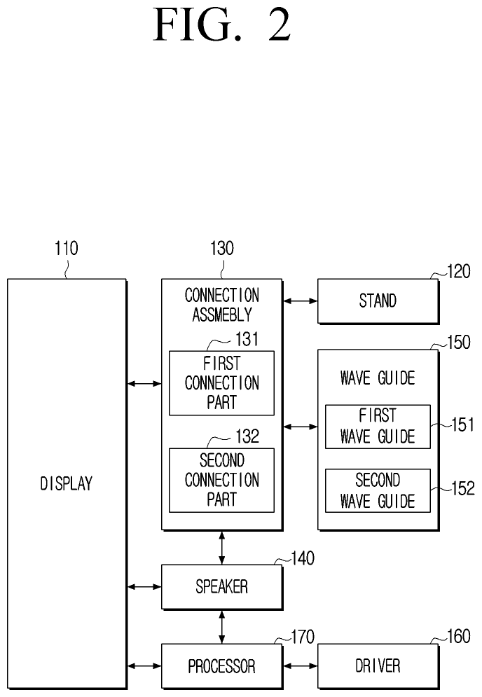

FIG. 2 is a block diagram illustrating a configuration of a display device according to an embodiment.

With reference to FIG. 2, the display device 100 includes a display 110, a stand 120, a connection assembly 130, a speaker 140, a wave guide, a driver 160, and one or more processors 170.

In advance, the display 110 may be implemented as various shapes of displays such as a liquid crystal display (LCD), an organic light-emitting diode (OLED), Liquid Crystal on Silicon (LCoS), a Digital Light Processing (DLP) display panel, a quantum dot (QD) display panel, a quantum dot light-emitting diode (QLED), or a Micro light-emitting diode (uLED).

The display 100 may be implemented as a touch screen coupled to a touch sensor, a flexible display, a rollable display, a 3D display, a display in which a plurality of display modules are physically connected, or the like.

The stand 120 may fix the display 110. For example, as shown in FIG. 1, the stand 120 may be implemented as a support in a stand form for use of standing the display 110 on a bottom surface (or the ground, etc.). The disclosure is not limited thereto and the stand 120 may be implemented as a support in a wall-mounted form for use of fixing the display 110 to the wall and may be implemented as a support in an arm shape for attaching (or fastening) it to a table, etc. A shape of the stand 120 shown in FIG. 1 is an example and a shape of the stand 120 may be variously implemented.

The display device 100 may include a connection assembly 130, and the connection assembly 130 may include a first connection art 131 and a second connection part 132. The connection assembly 130 may connect the display 110 and the stand 120. As an example, the connection assembly 130 may include the first connection part 131 provided on, affixed on, or located on a rear surface of the display 110 and rotating when the display 110 rotates (or rotating together when the display 110 rotates) and the second connection part 132 provided on a front surface of the stand 120 and fixed when the display 110 rotates.

The display device 100 may include a speaker 140 provided on the rear surface of the display 110. Here, the speaker 140 is a component having a sound output function which generates and copies a sound wave with a vibration of a diaphragm under control of one or more processors 170.

According to an embodiment, the speaker 140 is implemented as plural numbers and sound having a plurality of different channels (e.g. a stereo channel, a 5.1 channel, etc.) may be outputted through a plurality of speakers 140. For example, the one or more processors 170 may output 3-dimensional sound through the plurality of speakers 140.

For example, the speaker 140 may include a first speaker and a second speaker, wherein the first speaker may output left channel sound and the second speaker may output right channel sound among sound of a stereo channel.

The above is an example, and the speaker 140 may output mono channel sound through one speaker 140. Also, the speaker 140 may output left channel sound through the first speaker, may output right channel sound through the second speaker, and may output nondirectional and low frequency (or very low-pitched sound of 16 Hz to 60 Hz, low-pitched sound of 60 Hz to 250 Hz) sound (e.g. woofer channel sound) through the third speaker.

The display device 100 includes a wave guide (or an acoustic wave guide). As an example, the wave guide may be prepared in a center of the speaker 140 on the rear surface of the display 110. Here, the wave guide is a physical structure for guiding a sound wave outputted by the speaker 140. For example, the sound wave (i.e. sound) outputted by the speaker 140 may pass through the wave guide and may be transferred to an external part or aspect of a main body of the display 110, for example, each of the left side and the right side of the display 110.

According to an embodiment, the wave guide is provided on the rear surface of the display 110 and includes a first wave guide 151 corresponding to a landscape mode and a second wave guide 152 corresponding to a portrait mode.

According to an example, in the landscape mode of the display device 100, sound of the speaker 140 is outputted to the outside through the first wave guide 151 and in the portrait mode, sound of the speaker 140 is outputted to the outside through the second wave guide 152. The detailed description with respect to the above is after-mentioned.

According to an example, the display device 100 includes a driver 160.

The driver 160 may rotate the display 110. Specifically, the driver 160 is connected to a gear (e.g. a circular gear) coupled to the display 110 and may rotate the display 110 by rotating the gear according to control of the one or more processors 170. Otherwise, the driver 160 may stop rotation of the display 110 by stopping rotation of the gear according to control of the one or more processors 170.

For the above, the driver 160 may be implemented as a step motor which may generate a rotation force but it is merely an example, wherein the driver 160 may be implemented as various motors such as an AC motor and a DC motor.

If the display device 100 includes the driver 160, the display 110 may rotate according to driving of the driver 160. That is, if a user input for changing a display mode of the display 110 is received, the one or more processors 170 may control the driver 160 to rotate the display 110.

Here, the display 110 may rotate with reference to a rotation center in a state that a front surface maintains a certain direction. Here, the rotation center may be positioned at a geometric center of the display 110 but is not necessarily limited thereto and may be positioned at a different position of the display 110.

According to an example, the user may directly rotate the display 110.

For example, the user may freely rotate the display 110 at 0° to 360° (otherwise, in a clockwise direction or a counterclockwise direction) with the user's hands, wherein the display may operate in the landscape mode if the user rotates it at 0° (no rotation) or 180° and the display may operate in the portrait mode if the user rotates it at 90° or 270° with reference to the landscape mode in which a horizontal ratio of the display 110 is longer than a vertical ratio thereof.

According to an example, the display device 100 may provide a sound effect if a rotation angle of the display 110 arrives at each of 0°, 90°, 180°, 270°, 360° with reference to the ground where the display device 100 is positioned while the display 110 rotates, and connection sound (e.g. a click) may occur according to connection between a hole included in the first connection part 131 and a hole included in the second connection part 132.

According to an example, the one or more processors 170 may control operations of the display device 100 overall.

According to an example of the disclosure, the processor 170 may be implemented as a digital signal processor (DSP) processing a digital signal, a microprocessor, or a time controller (TCON). The disclosure is not limited thereto, and it may include one or more of a central processing unit (CPU), a micro controller unit (MCU), a micro processing unit (MPU), a controller, an application processor (AP), or a communication processor (CP), an ARM processor, or an AI processor or may be defined by the relevant terms. Also, the processor 170 may be implemented as a system on chip (SoC) in which processing algorithm is embedded or a large scale integration (LSI) and may be implemented in a form of a field programmable gate array (FPGA). The processor 170 may perform various functions by executing computer executable instructions stored in the memory.

The one or more processors 170 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 170 may control one or any combination of other components of the electronic device and perform an operation related to communication or data processing. The one or more processors 170 may perform one or more programs or instructions stored in the memory. For example, the one or more processors 170 may perform a method according to an embodiment of the disclosure by executing one or more instructions stored in the memory.

If a method according to an embodiment of the disclosure includes a plurality of operations, the plurality of operations may be performed by one processor and may be performed by a plurality of processors. For example, when a first operation, a second operation, and a third operation are performed by a method according to an embodiment, all of the first operation, the second operation, and the third operation may be performed by a first processor and also, the first operation and the second operation are performed by the first processor (e.g. a general purpose processor) and the third operation may be performed by a second processor (e.g. an Artificial Intelligence (AI)-dedicated processor).

The one or more processors 170 may be implemented as a single core processor including one core and may be implemented as one or more multi core processors including a plurality of cores (e.g. homogeneous multicores or heterogeneous multicores). If the one or more processors 170 are implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor and may be performed by the plurality of cores. For example, when a first operation, a second operation, and a third operation are performed by a method according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the disclosure, a processor may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, or a machine learning accelerator but embodiments of the disclosure are not limited thereto.

In particular, according to an example, one or more processors 170, if receiving a user input for changing a display mode, may control the driver 160 to rotate the display 110.

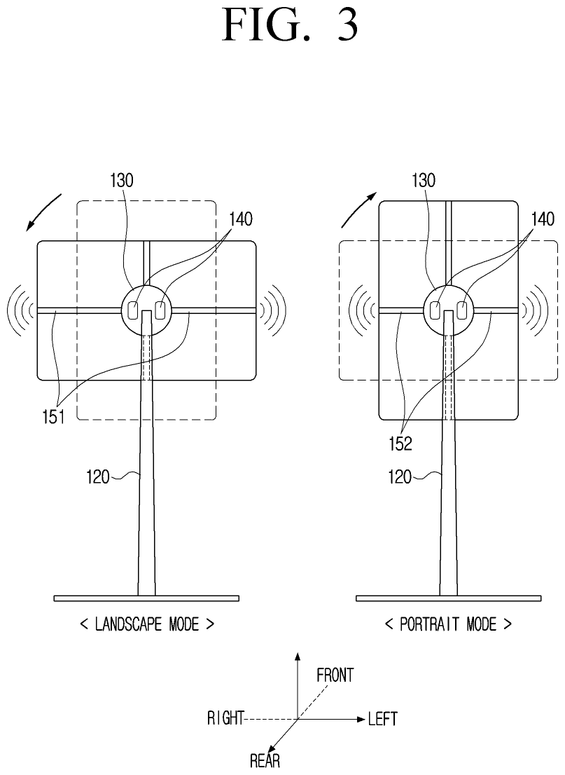

FIG. 3 is a view illustrating a rear surface of a display device in each of the landscape mode and the portrait mode according to an embodiment.

FIG. 3 is a rear view of the display device 100. With reference to FIG. 3, the one or more processors 170, if the display 110 is in a landscape mode, may output sound of the speaker 140 through the first wave guide 151.

Therefore, in the landscape mode, the display device 100 may output sound through the first wave guide 151 to each of the left side and the right side with reference to a front surface of the display device 100.

Also, the one or more processors 170, if the display 110 is in a portrait mode, may output sound of the speaker 140 through the second wave guide 152.

Therefore, in the portrait mode, the display device 100 may output sound to each of the left side and the right side with reference to a front surface of the display device 100 through the second wave guide 152.

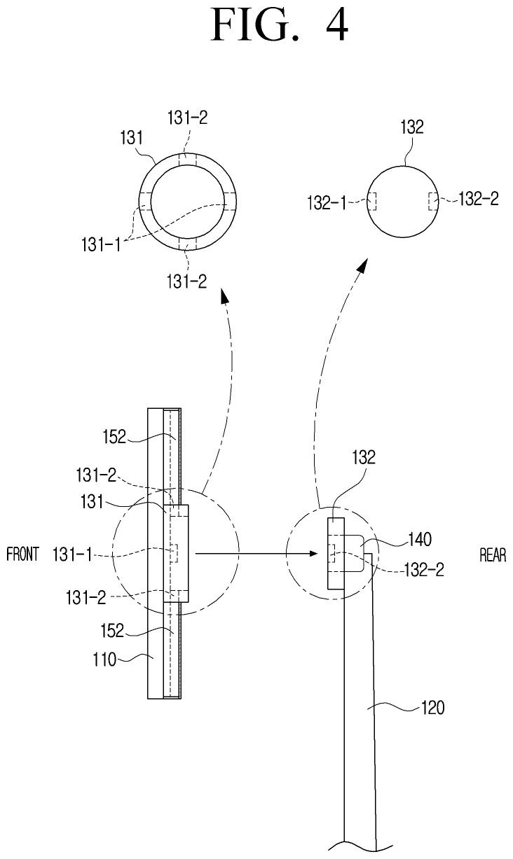

A connection assembly 130 is provided between the speaker 140 and a wave guide 150, wherein in the landscape mode of the display device 100, the connection assembly 130 may connect the speaker 140 and the first wave guide 151 corresponding to the landscape mode and in the portrait mode of the display device 100, the connection assembly 130 may connect the speaker 140 and the second wave guide 152 corresponding to the portrait mode. The detailed description with respect to the above will be made with reference to FIG. 4.

FIG. 4 is a right side view illustrating first and second connection parts connecting a display and a stand according to an embodiment.

With reference to FIG. 4, the connection assembly 130 may include a first connection part 131 provided on a rear surface of the display 110 and rotating when the display 110 rotates (rotating together with the display 110). Also, the connection assembly 130 may include a second connection part 132 provided on a front surface of the stand 120 and fixed when the display 110 rotates.

Here, the display 110 and the stand 120 may be connected according to coupling of the first connection part 131 and the second connection part 132.

According to an embodiment, the first connection part 131 may include a plurality of holes 131-1 corresponding to a landscape mode and a plurality of holes 131-2 corresponding to a portrait mode.

Here, any one hole of a plurality of holes 131-1 corresponding to the landscape mode may correspond to a left direction with reference to the front surface of the display device 100 in the landscape mode and the other one hole may correspond to the right direction with reference to the front surface of the display device 100 in the landscape mode.

Also, any one hole of a plurality of holes 131-2 corresponding to the portrait mode may correspond to a left direction with reference to the front surface of the display device 100 in the portrait mode and the other one hole may correspond to the right direction with reference to the front surface of the display device 100 in the portrait mode.

According to an example, the second connection part 132 may include a first hole 132-1 corresponding to the first direction and a second hole 132-2 corresponding to the second direction with reference to the speaker 140.

Here, with reference to the speaker 140, the first direction may correspond to the left direction with reference to the front surface of the display device 100 and the second direction may correspond to the right direction with reference to the front surface of the display device 100.

An upper end of FIG. 4 is a front view showing the first connection part 131 and the second connection part 132 for illustrating the first connection part 131 and the second connection part 132, and a lower end of FIG. 4 is a right side view showing the display 110 and the stand 120 for illustrating connection of the display 110 and the stand 120.

As shown in the lower end of FIG. 4, if the first connection part 131 and the second connection part 132 are connected, the display 110 and the stand 120 may be connected. Here, the first connection part 131 may surround the second connection part 132 to be coupled to the second connection part 132.

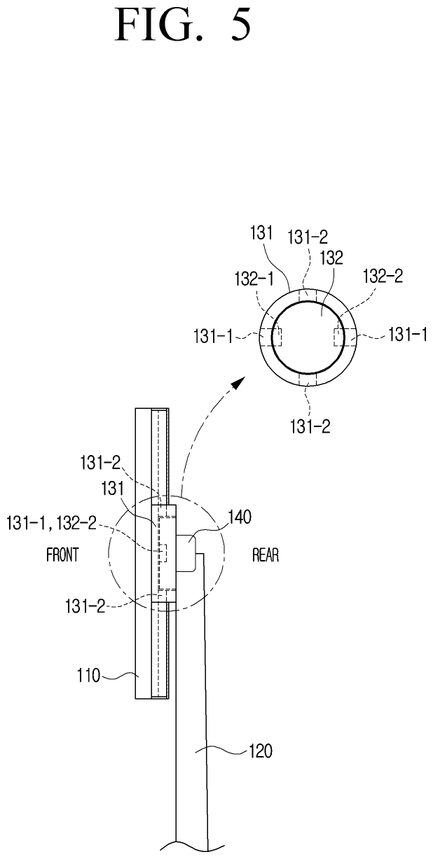

FIG. 5 is a right side view illustrating coupling of a first connection part and a second connection part according to an embodiment.

An upper end of FIG. 5 is a front view of a state in which the first connection part 131 and the second connection part 132 are coupled in the landscape mode of the display device 100.

As an example, if the second connection part 132 is inserted into an inside of the first connection part 131, the first connection part 131 may surround the second connection part 132 to be coupled to the second connection part 132.

Here, the first hole 132-1 corresponding to the first direction of the second connection part 132 may be connected to any one hole of a plurality of holes 131-1 corresponding to the landscape mode of the first connection part 131.

Also, the second hole 132-2 corresponding to the second direction of the second connection part 132 may be connected to the other one hole of the plurality of holes 131-1 corresponding to the landscape mode of the first connection part 131.

Therefore, the one or more processors 170, if identifying an event for changing the portrait mode to the landscape mode (e.g. an event receiving a user input for changing a display mode), may control the driver 160 to rotate the first connection part 131 to connect the plurality of holes 131-1 corresponding to the landscape mode to each of the first hole 132-1 corresponding to the first direction and the second hole 132-2 corresponding to the second direction.

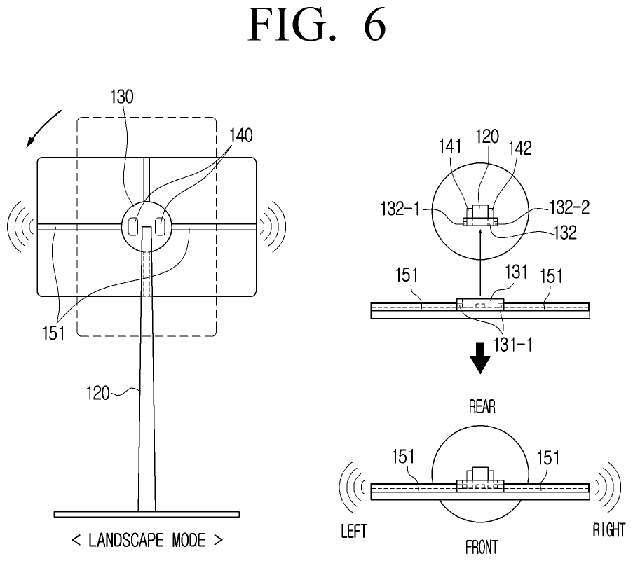

FIG. 6 is a rear view and a plan view of a display device in a landscape mode according to an embodiment.

With reference to a plan view of the display device 100 in the landscape mode, the speaker 140 may include the first speaker 141 and the second speaker 142, the first speaker 141 may be connected to the first hole 132 corresponding to the first direction, and the second speaker 142 may be connected to the second hole 132 corresponding to the second direction.

As an example, the plurality of holes 131-1 corresponding to the landscape mode included in the first connection part 131 may include a hole provided on a left side and a hole provided on a right side with reference to the front surface of the display 110 in the landscape mode.

Here, the hole provided on the left side may be connected to a wave guide prepared in a left direction with reference to the front surface of the display 110 in the landscape mode of the first wave guide 151. Also, the hole provided on the right side may be connected to a wave guide prepared in a right direction with reference to the front surface of the display 110 in the landscape mode of the first wave guide 151.

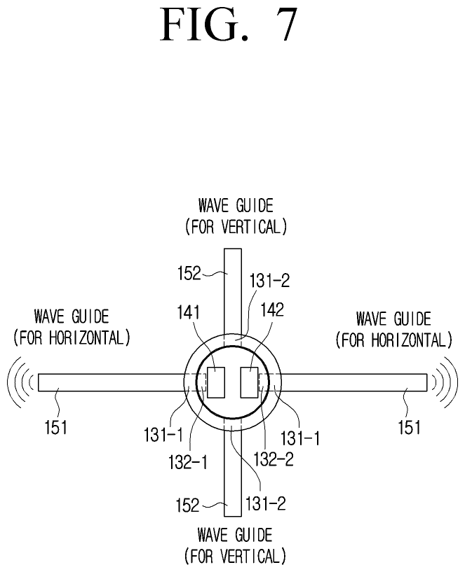

According to an embodiment, while the display device 100 operates in the landscape mode, sound of the speaker 140 is outputted through the first hole 132-1, the second hole 132-2, the plurality of holes 131-1 corresponding to the landscape mode, and the first wave guide 151, wherein the detailed description with respect to the above will be made with reference to FIG. 7.

FIG. 7 is a view illustrating a first connection part, a second connection part, and a wave guide in a landscape mode according to an embodiment.

FIG. 7 is a front view showing the first connection part 131, the second connection part 132, and the wave guide 150 in the landscape mode for convenience of the description.

With reference to FIG. 7, the first speaker 141 may be connected to the first hole 132-1 corresponding to the left direction, the first hole 132-1 may be connected to the hole provided on the left side of the plurality of holes 131-1 corresponding to the landscape mode, and the hole provided on the left side may be connected to the wave guide prepared in a left direction of the first wave guide 151.

Also, the second speaker 142 may be connected to the second hole 132-2 corresponding to the right direction, the second hole 132-2 may be connected to the hole provided on the right side of the plurality of holes 131-1 corresponding to the landscape mode, and the hole provided on the right side may be connected to the wave guide prepared in a right direction of the first wave guide 151.

Therefore, if the speaker 140 outputs sound of the stereo channel, left channel sound outputted by the first speaker 141 may be outputted to the outside (a left side of the display device 100 of the landscape mode) through the first hole 132-1, the hole provided on the left side, and the wave guide prepared in the left direction of the first wave guide 151.

Also, right channel sound outputted by the second speaker 142 may be outputted to the outside (a right side of the display device 100 of the landscape mode) through the second hole 132-2, the hole provided on the right side, and the wave guide prepared in the right direction of the first wave guide 151.

The aforementioned example was described under the assumption that the display device 100 is in the landscape mode and hereinafter, the portrait mode of the display device 100 will be described.

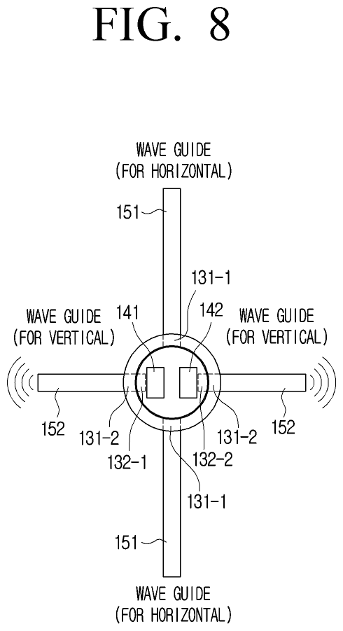

FIG. 8 is a view illustrating a first connection part, a second connection part, and a wave guide in a portrait mode according to an embodiment.

According to an example, the one or more processors 170, if identifying an event for changing the landscape mode to the portrait mode (e.g. an event receiving a user input for changing a display mode), may control the driver 160 to rotate the first connection part 131 to connect a plurality of holes 131-2 corresponding to the portrait mode to each of the first hole 132-1 corresponding to the first direction and the second hole 132-2 corresponding to the second direction.

With reference to FIG. 8, the first speaker 141 may be connected to the first hole 132-1 corresponding to the left direction, the first hole 132-1 may be connected to the hole provided on the left side of the plurality of holes 131-1 corresponding to the portrait mode, and the hole provided on the left side may be connected to the wave guide prepared in a left direction of the second wave guide 152.

Also, the second speaker 142 may be connected to the second hole 132-2 corresponding to the right direction, the second hole 132-2 may be connected to the hole provided on the right side of the plurality of holes 131-2 corresponding to the portrait mode, and the hole provided on the right side may be connected to the wave guide prepared in a right direction of the second wave guide 152.

Therefore, if the speaker 140 outputs sound of the stereo channel, left channel sound outputted by the first speaker 141 may be outputted to the outside (a left side of the display device 100 of the portrait mode) through the first hole 132-1, the hole provided on the left side, and the wave guide prepared in the left direction of the second wave guide 151.

Also, right channel sound outputted by the second speaker 142 may be outputted to the outside (a right side of the display device 100 of the portrait mode) through the second hole 132-2, the hole provided on the right side, and the wave guide prepared in the right direction of the second wave guide 152.

When comparing FIG. 7 to FIG. 8, in the landscape mode, each of the plurality of holes 131-1 corresponding to the landscape mode in the first connection part 131 is connected to the first hole 131-1 and the second hole 131-2, and each of the plurality of holes 131-2 corresponding to the portrait mode may be closed (i.e. may not be connected to the first hole 132-1 and the second hole 132-2 included in the second connection part 132).

For example, in the landscape mode, all of the first hole 131-1, any one (a hole provided on a left side) of the plurality holes 131-1 corresponding to the landscape mode, and any one of the first wave guide 151 (a wave guide prepared in a left direction) are connected and thus, sound outputted by the first speaker 141 may be outputted to a left side with reference to the front surface of the display 110 of the landscape mode.

Also, in the landscape mode, all of the second hole 131-2, the other one (a hole provided on a right side) of the plurality holes 131-1 corresponding to the landscape mode, and the other one of the first wave guide 151 (a wave guide prepared in a right direction) are connected and thus, sound outputted by the second speaker 142 may be outputted to a right side with reference to the front surface of the display 110 of the landscape mode.

As another example, in the portrait mode of the display device 100, each of the plurality of holes 131-2 corresponding to the portrait mode in the first connection part 131 is connected to the first hole 131-1 and the second hole 131-2, and each of the plurality of holes 131-2 corresponding to the portrait mode may be closed (i.e. may not be connected to the first hole 132-1 and the second hole 132-2 included in the second connection part 132).

For example, in the portrait mode, all of the first hole 131-1, any one (a hole provided on a left side) of the plurality holes 131-2 corresponding to the portrait mode, and any one of the second wave guide 152 (a wave guide prepared in a left direction) are connected and thus, sound outputted by the first speaker 141 may be outputted to a left side with reference to the front surface of the display 110 of the portrait mode.

Also, in the portrait mode, all of the second hole 131-2, the other one (a hole provided on a right side) of the plurality holes 131-2 corresponding to the portrait mode, and the other one of the second wave guide 152 (a wave guide prepared in a right direction) are connected and thus, sound outputted by the second speaker 142 may be outputted to a right side with reference to the front surface of the display 110 of the portrait mode.

Therefore, even if the display device 100 according to an example of the disclosure includes less than four (e.g. two) speakers, it may output sound to each of the left side and right side in the landscape mode and may output sound to each of the left side and right side in the portrait mode.

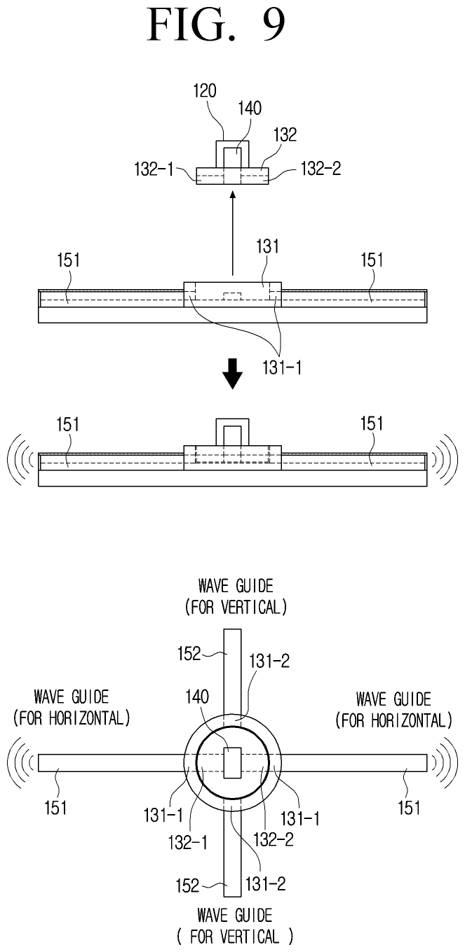

FIG. 9 is a plan view illustrating a speaker according to an embodiment.

The aforementioned example was described under the assumption that the speaker 140 includes the first speaker 141 and the second speaker 142 but the disclosure is not limited thereto.

With reference to FIG. 9, the speaker 140 may include one speaker 140. According to an example, the speaker 140 may include a single speaker unit outputting sound of a mono channel and may include a plurality of speaker units outputting sound of a stereo channel. For example, if the speaker 140 includes the plurality of speaker units, the display device 100 may include one speaker 140 which is not separated into the first speaker 141 and the second speaker unit 142 in the aforementioned example but has a form in which a speaker unit corresponding to the first speaker 141 is combined with a speaker unit corresponding to the second speaker 142. As another example, the speaker 140 may be implemented as one speaker 140 including a single speaker unit outputting sound of the mono channel.

According to an example, the first hole 132-1 corresponding to the first direction may be connected to one side of the speaker 140, and the second hole 132-2 corresponding to the second direction may be connected to the other side of the speaker 140. Here, one side of the speaker 140 may correspond to a first direction and the other side may correspond to a second direction.

According to an example, in the landscape mode of the display device 100, one side of the speaker 140 may be connected to the first hole 132-1, the first hole 132-1 may be connected to the hole provided on the left side of the plurality of holes 131-1 corresponding to the landscape mode, and the hole provided on the left side may be connected to the wave guide prepared in a left direction of the first wave guide 151.

Also, the other side of the speaker 140 may be connected to the second hole 132-2, the second hole 132-2 may be connected to the hole provided on the right side of the plurality of holes 131-1 corresponding to the landscape mode, and the hole provided on the right side may be connected to the wave guide prepared in a right direction of the first wave guide 151.

In the landscape mode, sound outputted by the speaker 140 may sequentially pass through the first hole 132-1, a hole provided on a left side of the plurality of holes 131-1 corresponding to the landscape mode, and a wave guide prepared in a left direction of the first wave guide 151 and be outputted to the outside (a left side) and may pass through the second hole 132-2, a hole provided on a right side of the plurality of holes 131-1 corresponding to the landscape mode, and a wave guide prepared in a right direction of the first wave guide 151 and be outputted to the outside (a right side).

According to an example, in the portrait mode of the display device 100, one side of the speaker 140 may be connected to the first hole 132-1, the first hole 132-1 may be connected to the hole provided on the left side of the plurality of holes 131-2 corresponding to the portrait mode, and the hole provided on the left side may be connected to the wave guide prepared in a left direction of the second wave guide 152.

Also, the other side of the speaker 140 may be connected to the second hole 132-2, the second hole 132-2 may be connected to the hole provided on the right side of the plurality of holes 131-2 corresponding to the portrait mode, and the hole provided on the right side may be connected to the wave guide prepared in a right direction of the second wave guide 152.

In the portrait mode, sound outputted by the speaker 140 may sequentially pass through the first hole 132-1, a hole provided on a left side of the plurality of holes 131-2 corresponding to the portrait mode, and a wave guide prepared in a left direction of the second wave guide 152 and be outputted to the outside (a left side) and may pass through the second hole 132-2, a hole provided on a right side of the plurality of holes 131-2 corresponding to the portrait mode, and a wave guide prepared in a right direction of the second wave guide 152 and be outputted to the outside (a right side).

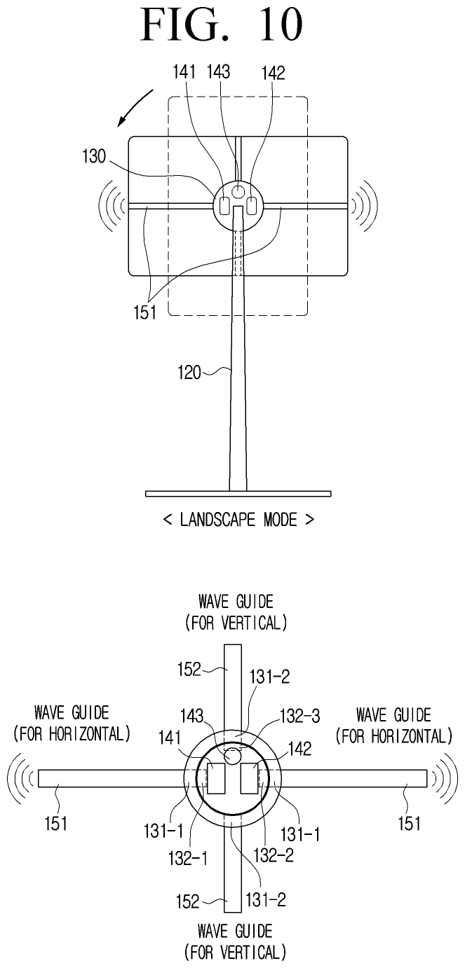

FIG. 10 is a rear view illustrating a speaker according to an embodiment.

According to an example of the disclosure, the display device 100 may output sound of various channels besides sound of a mono channel and sound of a stereo channel.

For example, as shown in FIG. 10, the speaker 140 may further include a third speaker 143 besides a first speaker 141 and a second speaker 142.

Here, the third speaker 143 may output sound of a woofer channel.

As shown in an lower end of FIG. 10, a second connection part 132 may further include a third hole 132-3 corresponding to a third direction with reference to the speaker 140, and the third hole 132-3 may be connected to the third speaker 143.

According to an example, if the display device 100 is in a landscape mode, sound of the woofer channel outputted by the third speaker 143 may be outputted to the outside (an upper side or a lower side of the display device 100 of the landscape mode) through the third hole 132-3, any one hole connected to the third hole 132-3 of the plurality of holes 131-2 corresponding to the portrait mode, and any one wave guide of the second wave guide 152.

Here, the third speaker 143 may output nondirectional and low-pitched sound of less than 100 Hz (e.g. sound of neither a left channel nor a right channel) and if the display device 100 is in a landscape mode, the display device 100 may output directional sound (e.g. sound of the left channel and sound of the right channel) to each of the left side and the right side and may output nondirectional sound to at least one of an upper side or a lower side through the first wave guide.

As another example, if the display device 100 is in a portrait mode, sound of the woofer channel outputted by the third speaker 143 may be outputted to the outside (an upper side or a lower side of the display device 100 of the portrait mode) through the third hole 132-3, any one hole connected to the third hole 132-3 of the plurality of holes 131-1 corresponding to the landscape mode, and any one wave guide of the first wave guide 151.

Returning to FIG. 2, according to an embodiment of the disclosure, the one or more processors 170, if the display device 100 is in the landscape mode, may relatively amplify an output level of sound outputted by the speaker 140 compared to when the display device 100 is in the portrait mode.

For example, a length of the wave guide (i.e. the first wave guide 151) through which sound outputted by the speaker 140 passes in the landscape mode is relatively longer than a length of the wave guide (i.e. the second wave guide 152) through which sound outputted by the speaker 140 passes in the portrait mode. According to an example, the one or more processors 170, if the display device 100 is in a landscape mode, may relatively amplify and output an output level of sound outputted by the speaker 140 compared to when the display device is in the portrait mode based on a relative difference in lengths between the first wave guide 151 and the second wave guide 152.

A thickness (or a width) of each of the first wave guide 151 and the second wave guide 152 may be the same or different.

For example, a thickness of each of the first wave guide 151 and the second wave guide 152 may correspond to a size of a diaphragm (or an edge) of the speaker 140.

As another example, the first wave guide 151 may be implemented in a relatively thicker thickness and inversely, may be implemented in a relatively thinner thickness than a thickness of the second wave guide 152. For example, it may be implemented that a length of the first wave guide 151 is relatively longer that a length of the second wave guide 152, and a thickness of the first wave guide 151 is relatively thinner than a thickness of the second wave guide 152.

Also, a thickness of a wave guide prepared in a left side may be the same as and may be different from that of a wave guide prepared in a right side of the first wave guide 151 with reference to the front surface of the display 110.

Also, a thickness of a wave guide prepared in a left side may be the same as and may be different from that of a wave guide prepared in a right side of the second wave guide 152 with reference to the front surface of the display 110.

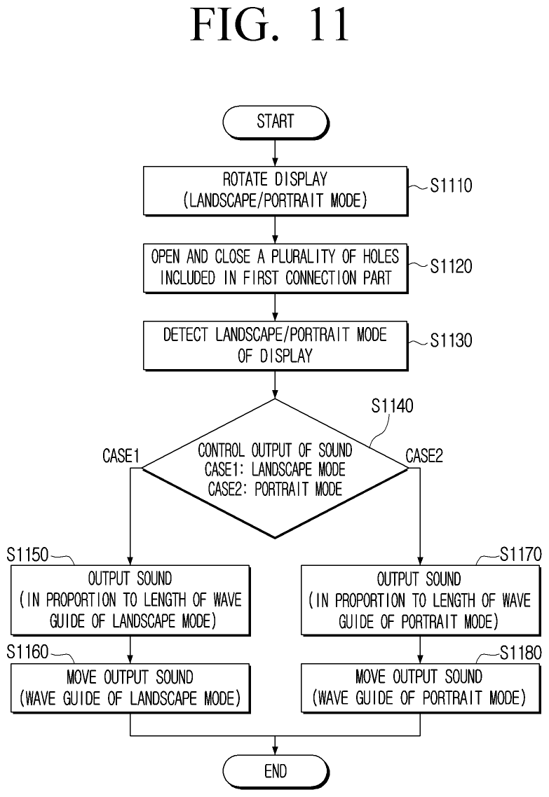

FIG. 11 is a flow chart illustrating a method of controlling a display device according to an embodiment.

According to an embodiment, in a method of controlling a display device, the display device operates in any one display mode of a landscape mode or a portrait mode (S1110).

Then, the method includes opening and closing a plurality of holes included in the first connection part 131 according to the display mode (S1120). For example, the method may include, if the display device 100 is in a landscape mode, opening a plurality holes 131-1 corresponding to the landscape mode of the plurality of holes included in the first connection part 131 and closing the plurality of holes 131-2 corresponding to the portrait mode (S1120).

Here, the opening may mean a state of connecting to a plurality holes included in the second connection part 132 (e.g. the first hole 132-1 and the second hole 132-2), and the closing may mean a state of not connecting to the plurality of holes included in the second connection part 132 (e.g. the first hole 132-1 and the second hole 132-2).

For example, the method may include, if the display device 100 is in a portrait mode, opening a plurality holes 131-2 corresponding to the portrait mode of the plurality of holes included in the first connection part 131 and closing the plurality of holes 131-1 corresponding to the landscape mode (S1120).

Then, the control method may include detecting a display mode of the display device 100 (S1130).

Thereafter, if the display mode of the display device 100 is in the landscape mode (S1140, Case 1), sound may be outputted based on the landscape mode (S1150).

Then, sound outputted by the speaker 140 of the display device 100 may be outputted to the outside through the wave guide (i.e. the first wave guide 151) corresponding to the landscape mode (S1160).

Also, if the display mode of the display device 100 is in the portrait mode (S1140, Case 2), sound may be outputted based on the portrait mode (S1170).

Then, sound outputted by the speaker 140 of the display device 100 may be outputted to the outside through the wave guide (i.e. the second wave guide 152) corresponding to the portrait mode (S1180).

In the step S1150, the one or more processors 170, if the display device 100 is in the landscape mode, may relatively amplify an output level of sound outputted by the speaker 140 compared to when the display device 100 is in the portrait mode and if the display device 100 is in the portrait mode, may relatively reduce an output level of sound outputted by the speaker 140 compared to when the display device 100 is in the landscape mode.

It will be readily understood that various embodiments of the disclosure may be applied to various types of electronic devices besides the display device.

Various embodiments described as above may be implemented in a recording medium that may be read by a computer or a device similar thereto by using software, hardware, or a combination thereof. In some cases, embodiments described in the specification may be implemented as a processor itself. According to software implementation, embodiments such as procedures and functions described in the specification may be implemented as separate software modules. Each of software modules may perform one or more functions and operations described in the specification.

Computer instructions for performing the processing operation of the electronic device according to the various embodiments of the disclosure may be stored in a non-transitory computer readable medium. Computer instructions stored in this non-transitory computer readable medium that, when executed by a processor of a specific device, causes the specific device to perform a processing operation of the electronic device according to the various embodiments.

The non-transitory computer readable medium does not mean a medium that stores data for a short time such as a resistor, a cache, memory, or the like but a machine readable medium that stores data semipermanently. A specific example of the non-transitory computer readable medium may be a CD, a DVD, a hard disk, a Blu-ray disk, a USB, a memory card, ROM, etc.

Although example embodiments of the present disclosure are shown and described, it will be understood that the disclosure is not limited to the aforementioned specific examples and various modifications may be implemented by those skilled in the art without deviating from the gist of the disclosure claimed in the scope of claims, wherein these modifications should not be independently understood from the technical spirit or prospect of the disclosure.

What is claimed is:

1. A display device comprising:
a display operable in a landscape mode and in a portrait mode;
a stand supporting the display;
a connection assembly connecting the display and the stand;
a speaker on a rear surface of the display; and
a wave guide in the speaker on the rear surface of the display,
wherein the wave guide comprises:
a first wave guide on the rear surface of the display; and
a second wave guide on the rear surface of the display,
wherein, in the landscape mode, the first wave guide is configured to output a sound of the speaker therethrough, and
wherein, in the portrait mode, the second waveguide is configured to output the sound of the speaker therethrough.

2. The display device of claim 1, wherein the connection assembly comprises:
a first connection part on the rear surface of the display and configured to rotate when the display rotates; and
a second connection part on a front surface of the stand and configured to remain fixed when the display rotates,
wherein the first connection part comprises a first plurality of holes corresponding to the landscape mode and a second plurality of holes corresponding to the portrait mode, and
wherein the second connection part comprises a first hole corresponding to a first direction with respect the speaker and a second hole corresponding to a second direction with respect to the speaker.

3. The display device of claim 2, further comprising:
a driver configured to orient the display in the landscape mode or the portrait mode by rotating the display; and
one or more processors configured to control the driver, based on an event for changing the portrait mode to the landscape mode being identified, to rotate the display such that the first plurality of holes are connected to each of the first hole and the second hole,
wherein, while the display operates in the landscape mode, the sound of the speaker is output through the first hole, the second hole, the first plurality of holes, and the first wave guide.

4. The display device of claim 3, wherein the first plurality of holes are provided on each of a first side and a second side with respect to a front surface of the display in the landscape mode,
wherein a hole of the first plurality of holes provided on the first side is connected to the first wave guide in a left direction with respect to the front surface of when the display is in the landscape mode, and
wherein a hole of the second plurality of holes provided on the right side is connected to the first wave guide in a right direction with respect to the front surface of when the display is in the landscape mode.

5. The display device of claim 4, wherein the speaker comprises:
a first speaker connected to the first hole; and
a second speaker connected to the second hole,
wherein left channel sound of the first speaker is output through the first hole, the hole provided on the left side, and the first wave guide in the left direction, and
wherein right channel sound of the second speaker is output through the second hole, the hole provided on the right side, and the first wave guide in the right direction.

6. The display device of claim 2, further comprising:
a driver configured to orient the display in the landscape mode or the portrait mode by rotating the display; and
one or more processors configured to control the driver, based on an event for changing the landscape mode to the portrait mode being identified, to rotate the display such that the second plurality of holes are connected to each of the first hole and the second hole,
wherein while the display operates in the portrait mode, the sound of the speaker is output through the first hole, the second hole, the second plurality of holes, and the second wave guide.

7. The display device of claim 6, wherein the second plurality of holes are on each of a left side and a right side with respect to a front surface of the display in the portrait mode,
wherein a hole of the second plurality of holes provided on the left side is connected to the second wave guide in a left direction with respect to the front surface of the display in the portrait mode, and
wherein a hole of the second plurality of holes provided on the right side is connected to the second wave guide in a right direction of the front surface of the display in the portrait mode.

8. The display device of claim 7, wherein the speaker comprises:
a first speaker connected to the first hole; and
a second speaker connected to the second hole,
wherein left channel sound of the first speaker is output through the first hole, the hole provided on the left side, and the second wave guide in the left direction, and
wherein right channel sound of the second speaker is output through the second hole, the hole provided on the right side, and the second wave guide in the right direction.

9. The display device of claim 8, wherein the second connection part further comprises:
a third hole corresponding to a third direction with respect to the speaker,
wherein the speaker comprises a third speaker connected to the third hole, and
wherein, while the display operates in the portrait mode, woofer channel sound of the third speaker is output through the third hole, any one hole connected to the third hole from among the first plurality of holes, and the first wave guide.

10. The display device of claim 1, further comprising:
one or more processors configured to, based on the display being in the landscape mode, amplify an output level of sound output by at least one speaker to be more than the output level of sound output when the display is in the portrait mode.

11. A method of controlling a display device, wherein the display device comprises:
a display operable in a landscape mode and in a portrait mode;
a stand supporting the display;
a connection assembly connecting the display and the stand;
a speaker on a rear surface of the display; and
a wave guide in the speaker on the rear surface of the display and comprising a first wave guide corresponding to the landscape mode and a second wave guide corresponding to the portrait mode,
wherein the method comprises:
outputting a sound output by the speaker through the first wave guide in the landscape mode; and
outputting the sound output by the speaker through the second wave guide in the portrait mode.

12. The method of claim 11, wherein the connection assembly comprises:
a first connection part on the rear surface of the display that rotates when the display rotates; and
a second connection part on a front surface of the stand and configured to remain fixed when the display rotates,
wherein the first connection part comprises a first plurality of holes corresponding to the landscape mode and a second plurality of holes corresponding to the portrait mode, and
wherein the second connection comprises a first hole corresponding to a first direction with respect to the speaker and a second hole corresponding to a second direction with respect to the speaker.

13. The method of claim 12, wherein the display device further comprises:
a driver configured to orient the display in the landscape mode or the portrait mode by rotating the display,
wherein the method further comprises:
identifying an event for changing the portrait mode to the landscape mode; and
based on the event being identified, controlling the driver to rotate the display such that the first plurality of holes are connected to each of the first hole and the second hole,
wherein the outputting the sound in the landscape mode comprises:
while the display operates in the landscape mode, outputting the sound through the first hole, the second hole, the first plurality of holes, and the first wave guide.

14. The method of claim 13, wherein the first plurality of holes are provided on each of a left side and a right side with respect to a front surface of the display in the landscape mode,
wherein a hole of the first plurality of holes provided on the left side is connected to the first wave guide in a left direction with respect to the front surface of the display in the landscape mode, and
wherein a hole of the first plurality of holes provided on the right side is connected to the first wave guide in a right direction with respect to the front surface of the display in the landscape mode.

15. The method of claim 14, wherein the speaker comprises:
a first speaker connected to the first hole; and
a second speaker connected to the second hole,
wherein left channel sound of the first speaker is output through the first hole, the hole provided on the left side, and the first wave guide in the left direction, and
wherein right channel sound of the second speaker is output through the second hole, the hole provided on the right side, and the first wave guide in the right direction.

16. The method of claim 12, wherein the display device further comprises:
a driver configured to orient the display in the landscape mode or the portrait mode by rotating the display; and
wherein the method further comprises:
identifying an event for changing the portrait mode to the landscape mode; and
based on the event being identified, controlling the driver to rotate the display such that the second plurality of holes are connected to each of the first hole and the second hole,
wherein the outputting the sound in the landscape mode comprises:
while the display operates in the portrait mode, outputting the sound of the speaker through the first hole, the second hole, the second plurality of holes, and the second wave guide.

17. The method of claim 16, wherein the second plurality of holes are provided on each of a left side and a right side with respect to a front surface of the display in the portrait mode,
wherein a hole of the second plurality of holes provided on the left side is connected to the second wave guide in a left direction with respect to the front surface of the display in the portrait mode, and
wherein a hole of the second plurality of holes provided on the right side is connected to the second wave guide in a right direction of the front surface of the display in the portrait mode.

18. The method of claim 17, wherein the speaker comprises:
a first speaker connected to the first hole; and
a second speaker connected to the second hole,
wherein left channel sound of the first speaker is output through the first hole, the hole provided on the left side, and the second wave guide in the left direction, and
wherein right channel sound of the second speaker is output through the second hole, the hole provided on the right side, and the second wave guide in the right direction.

19. The method of claim 18, wherein the second connection part further comprises:
a third hole corresponding to a third direction with respect to the speaker,
wherein the speaker comprises a third speaker connected to the third hole, and
wherein, while the display operates in the portrait mode, woofer channel sound of the third speaker is output through the third hole, any one hole connected to the third hole from among the first plurality of holes, and the first wave guide.

20. A non-transitory computer readable recording medium storing computer instructions that when executed by a processor of a display device, causes the display device to perform an operation, wherein the display device comprises:
a display operable in a landscape mode and in a portrait mode;
a stand supporting the display;
a connection assembly connecting the display and the stand;
a speaker on a rear surface of the display; and
a wave guide on the rear surface of the display and comprising a first wave guide corresponding to the landscape mode and a second wave guide corresponding to the portrait mode,
wherein the operation comprises:
outputting a sound output by the speaker through the first wave guide in the landscape mode; and
